(19) United States
(12) Patent Application Publication
(10) Pub. No.: US 2020/0041194 A1
(43) Pub. Date: Feb. 6, 2020

(54) METHOD OF REFRIGERATOR DECORATING

(71) Applicant: Erika Courter, New Brunswick, NJ (US)

(72) Inventor: Erika Courter, New Brunswick, NJ (US)

(21) Appl. No.: 16/053,230

(22) Filed: Aug. 2, 2018

(51) Int. Cl. F25D 23/02; F25D 27/00; F21V 33/00

(52) U.S. Cl. CPC F25D 23/028; F21W 2131/305; F21V 33/0044; F25D 27/00

(57) ABSTRACT

A method of refrigerator decorating that includes the steps of: placing a removable cover on at least one handle; and incorporating a decorative design in the removable cover. The removable cover preferably may include lighting or include glow in the dark features. The step of placing a removable cover on at least one handle includes placing a removable cover on a first handle and placing a removable cover on a second handle where the refrigerator includes two doors and two handles.

### BACKGROUND OF THE INVENTION

### Field of Invention

The present invention relates to method to decorate a standard refrigerator door handle.

### Description of Related Art

Refrigerators are a common household appliance used in most households. Refrigerators provide a means to store food and beverages for later consumption. A typical refrigerator includes at least one door with a handle that is used to open and close the door. A typical refrigerator handle is vertical and it is normally placed along one edge of the door. As stated at least one handle is available for most refrigerator doors. Some refrigerators have dual doors, one for a freezer compartment and a second for a refrigerator compartment at a cool temperature but above freezing. Some refrigerators with two doors are designed with side by side doors and others have compartments vertically stacked. Some homeowners enjoy adding decorations to their otherwise standard refrigerator. Many times magnetic decorations are placed on the covered surface of the refrigerator because most refrigerators are made of steel covering. However, limited options are available for adding decor to the handle of a refrigerator. It would be advantageous if there was a removable cover that could be placed over a handle by a decorative appearance for the refrigerator handle.

### SUMMARY OF THE INVENTION

The present invention relates to a method of refrigerator decorating that includes the steps of: placing a removable cover on at least one handle; and incorporating a decorative design in the removable cover. The removable cover preferably may include lighting or include glow in the dark features. The step of placing a removable cover on at least one handle includes placing a removable cover on a first handle and placing a removable cover on a second handle where the refrigerator includes two doors and two handles.

The present invention provides among other things a decorative accessory for a refrigerator to accent the decor of your kitchen. The removable cover also protects the handle from grease and dirty hands. The cover provides static shock protection since it installations the handle. With the addition of lighting features the cover provides illumination at night. A sensor may also be implemented to monitor and detect entry into the refrigerator. Finally, removable cover may be used to as a fund raiser to support various charities and organizations.

### BRIEF DESCRIPTION OF DRAWINGS

FIG. 1 depicts a removable cover for a refrigerator handle according to the present invention.

### DETAILED DESCRIPTION

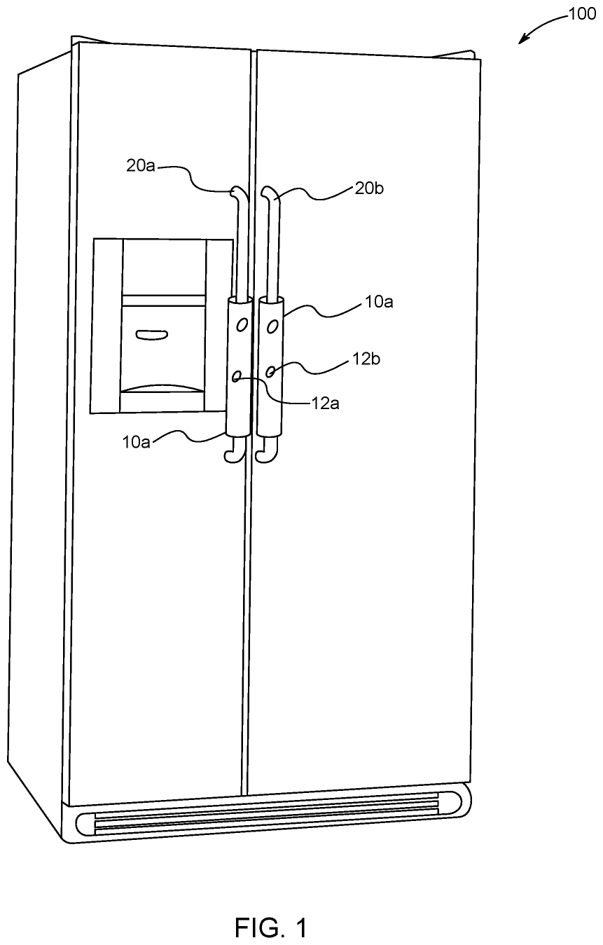

The present invention relates a removable cover that's placed around a conventional refrigerator door handle. This cover provides a decorative accessory to the standard refrigerator. In reference to FIG. 1, a refrigerator 100 is depicted. Refrigerator 100 includes a first handle 20a and a second handle 20b. Wrapped around a portion of each handle is a cover 10. A first cover 10a is wrapped around first handle 20a and a second cover 10b is wrapped around second handle 20b. These covers 10a, 10b include a slit opening, not shown, that provides a means to insert the cover onto the handle. Once onto the handle, the cover 10a, 10b is closed to provide a decorative covering accessory to refrigerator 100.

As such the removable covers 10a, 10b effectively provide the means and method of decorate the refrigerator 100. The cover 10 as shown may be placed upon at least one handle of a refrigerator where this covers 10a, 10b a decorative design. Further, lights as shown in FIG. 1 may be included in the removable cover. This lighting provides yet another decorative feature of the removable cover. The lighting may be substituted with a glow-in-the-dark feature therefore allowing not only decorating the refrigerator but allowing an illuminating feature to be added to the decorative cover.

Other features of the cover may include the incorporation of a sensor within the cover. The sensor provides a means to a monitor the activity of the use of the refrigerator. The sensor detects when the person may have opened the refrigerator. The sensor may also activate an audio sound emitted from the cover in order to provide a musical tune to be played when the user grabs the cover to open the refrigerator. The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. A method of refrigerator decorating comprising the steps of:
a. placing a removable cover on at least one handle; and
b. incorporating a decorative design in the removable cover.

2. The method of refrigerator decorating according to claim 1, where the removable cover includes lighting.

3. The method of refrigerator decorating according to claim 1, where the removable cover includes glow in the dark features.

4. The method of refrigerator decorating according to claim 1, where the step of placing a removable cover on at least one handle includes placing a removable cover on a first handle and placing a removable cover on a second handle.
